(19) United States
(12) Patent Application Publication
(10) Pub. No.: US 2016/0370248 A1
(43) Pub. Date: Dec. 22, 2016

(54) MOBILITY ASSISTANCE VEHICLE STABILITY ASSESSMENT

(71) Applicant: CONVENTRY UNIVERSITY, Coventry, West Midlands (GB)

(72) Inventors: Dimitar STEFANOV, Conventry (GB); Simon FIELDEN, Birmingham (GB); Alexander AVTANSKI, San Jose, CA (US)

(73) Assignee: Coventry University, Coventry, Warwickshire (GB)

(21) Appl. No.: 14/903,863

(22) PCT Filed: Jul. 9, 2014
(86) PCT No.: PCT/GB2014/052090

§ 371 Date: Jan. 8, 2016

(30) Foreign Application Priority Data
Jul. 9, 2013 (GB) 1312258.5

(51) Int. Cl. G01M 1/12; A61G 5/10; G01G 19/02

(52) U.S. Cl. CPC G01M 1/122; G01G 19/027; A61G 5/10; A61G 2203/42; A61G 2203/44

(57) ABSTRACT

A method of assessing the stability of a wheeled mobility assistance vehicle 1, by determining the position of the centre of gravity of the vehicle. There are arrays load sensors (8, 9, 10, 11) on which the wheels (3, 5) of the vehicle are placed, the sensor arrays providing data sufficient to permit determination of the position of a wheel. The sensor arrays supplying data to data processing means (13) which calculates from that data the load imposed by individual wheels of the vehicle, the positions of those individual wheels and thus distances between the wheels of the vehicle. The distances between wheels and the loads imposed by the heels of the vehicle are used to determine the position of the centre of gravity of the vehicle.

This invention relates to the stability assessment of a mobility assistance vehicle such as a wheelchair.

In this specification, “mobility assistance vehicle” means a vehicle adapted for use by a single person having a disability, injury or illness which makes it difficult or impossible for that person to walk. The type of vehicle concerned will normally be a wheelchair, powered wheelchair or a mobility scooter, where the stability of the vehicle is an issue and the stability of the vehicle needs to be assessed. The present invention is not concerned with larger vehicles such as cars or vans which have been adapted for use by people having disabilities, where there are not stability issues.

Many wheelchair stability assessment methods involve positioning a wheelchair and occupant on a platform which is inclined to check whether the wheelchair tips over when the platform is inclined to a specified angle. Typically, in the United Kingdom, this angle is 12° for attendant pushed wheelchairs, and 16° for occupant propelled or electric powered wheelchairs. This system can be distressing for the occupant. The present invention involves assessing stability by a method that involves calculating the position of the centre of gravity of the vehicle, using algorithms carried out on data processing equipment. Such methods have their basis in an algorithm proposed by Wawrzinek, A. and Boenick, U., in 1987, “The Dynamic Stability of Wheelchairs”, Biomedizinische Technik Berlin, 32, 313-319. A computerised system for carrying out such a method is evaluated in the paper by Caldicott, S. J. and Shapcott, N. in 2008, “Validation of a Software-Based Stability Assessment System for Wheelchairs and their Occupants”, Journal of Medical Engineering and Technology 32(6): 440-447. To avoid tipping, the projection of the centre of gravity must be within the footprint of the vehicle, as defined by the points of engagement of the wheels with the ground.

In a known system, four load cells are used, each associated with a plate underneath one of the four wheels of a wheelchair. Measurements are taken of the distances between wheels, using for example a tape measure and these distances and the loads measured by the load cells are used to calculate the centre of gravity of the wheelchair. The present invention aims to provide an improvement over such a system.

Viewed from one aspect the invention provides a method of assessing the stability of a wheeled mobility assistance vehicle having a plurality of wheels, by determining the position of the centre of gravity of the vehicle, using at least one array of load sensors on which the wheels of the vehicle are placed, the sensor array providing data sufficient to permit determination of the position of a wheel, the sensors of the array supplying data to data processing means which calculates from that data the load imposed by individual wheels of the vehicle, the positions of those individual wheels and thus distances between the wheels of the vehicle, and uses those distances and the loads imposed by the wheels of the vehicle to determine the position of the centre of gravity of the vehicle.

Thus, instead of there being four load platforms which measure only the load through a respective wheel of the vehicle, there is at least one array of sensors which can provide data usable not only to detect the load imposed by a wheel, but also the position of the wheel. The array of sensors could involve a plurality of sensors arranged in a grid formation. The load sensors can be of any type that will produce an electrical signal that can be detected, whether directly such as using a piezoelectric element or an element whose resistance, capacitance, current or magnetic field varies with load, or indirectly as in the case of a hydraulic or pneumatic load sensor.

By knowing the position of the centre of gravity of the vehicle, and the footprint of the vehicle as defined by the points of contact with the ground of the wheels of the vehicle, it is possible to determine a maximum safe tipping angle—forwards, backwards and optionally side to side—to ensure that the vertical projection of the centre of gravity remains within the footprint of the vehicle. This can be compared with the required values such as 12° for attendant pushed wheelchairs, and 16° for occupant propelled or electric powered wheelchairs.

In one embodiment there may be three or more separate load platforms, each associated with a respective array of sensor which measure the loads on the associated platform. There may, for example, be four load platforms, for use with four wheels of a wheelchair. Each array measures the load imposed on the respective platform by a wheel on the platform and determines the position of the wheel on the platform. The platforms are at known position with respect to each other and thus the distances between the contact points of wheels can be determined even though they are on different platforms. With such an arrangement, the loads on the individual sensors can be used to calculate the total load transmitted to the platform through the wheels (along the z axis) and using the load outputs from the sensors a suitable algorithm can determine the position of the point of contact of the wheel on the platform (i.e. the x and y coordinates on the platform). This can be done using known methods, for example that described in WO 1997/033143 of Weigh Tronix.

In such an arrangement in accordance with the present invention there may be a small number of sensors in the array, such as three or four. In one arrangement, each platform is provided with four sensors. If the platform is rectangular, e.g.

square, there can be one sensor arranged adjacent each corner in some embodiments.

In an arrangement with, for example, four load platforms, the array of sensors, such as four, associated with each platform is not used just to measure the load on the platform but also means the position of the wheel on the platform can be resolved.

In some embodiments of the invention, the accuracy of the determination of the point of contact should be such that the difference between the true position in the x and y directions and the calculated position should be no more than about 10 mm, preferably no more than about 8 mm, and typically may be between about 5 and 6 mm.

It will be appreciated that when there is a reference to a “point of contact”, in practice a wheelchair tyre may be in contact over a small footprint and the “point of contact” can be taken as a central point of this footprint or, for example, the position where the force on the platform is at a maximum.

The mobility assistance vehicle may be a wheelchair having four wheels, and for example a wheelchair having a pair of rear wheels of relatively large diameter, and a pair of front wheels of relatively small diameter. However, a wheelchair or other vehicle may have a different number of wheels such as six or eight, and the invention can also be used for a three wheeled vehicle. In the case of a mobility vehicle that uses Segway™ or iBot™ principles, the method can be used with a vehicle having two wheels. In general, though, the method of the invention is likely to be used mostly with vehicles having at least three or four wheels.

A wheelchair to which the assessment method is applied may be adapted for self propulsion or pushing by an attendant, or may be electrically powered. The invention is not restricted to wheelchairs and is applicable to other mobility assistance vehicles such as electrically powered mobility scooters. The mobility assistance vehicle will normally have a seat portion to carry an occupant.

Where the invention uses an array of sensors of suitably high resolution, if two wheels are on a single array, the system will detect the individual loads and the positions of the wheels.

For ease of construction or transportation, there may be a plurality of arrays, for example each on a separate base. When the arrays are to be used, the bases can be placed in a frame, or connected together, or used together in any other way such that the relative positions of the arrays are known. In this manner if one wheel is located on one array and one wheel is located on another array, by detecting the position of each wheel on its respective array it is possible to determine the positions of the wheels relative to each other and to calculate the distance between the wheels. Effectively, the coordinates of each wheel can be determined with respect to a global coordinate system extending across all arrays. There may for example be four arrays, each on its own base, but any number of arrays can be used together. In a preferred embodiment, the or each array is provided on a platform which is foldable or can be dismantled, so that the sub-platforms can be stacked on each other. When the system is folded or dismantled, the stacked sub-platforms can be transported easily in a car boot. This allows the usage of the system in field conditions, at the homes or workplaces of users etc., or wherever is most convenient for the user.

The data processing means may be a portable computing device such as a laptop computer or a tablet computer, using software. The software may give a graphic illustration of where the centre of gravity is located.

Preferably, the sensors in the or each array are monitored continuously, during an evaluation process. This means that the array can be used to give dynamic outputs as the vehicle is moved, or items are added to the vehicle or taken from the vehicle, which affect the centre of gravity. If there is a graphic illustration, it can show the effect on the centre of gravity of such changes. A known system measures the force reactions of the wheels only once but does not use continuous reading of the force reactions. Sometimes, the wheelchair may not be positioned correctly, for example in the case when one or more wheels do not make a proper contact with the platform surfaces or when the wheelchair is moving slightly on the platform. In such situations, the force readings are fluctuated continuously and if “snapshot” measurements are taken at that time, that will cause big errors. The system in a preferred embodiment of the invention gives continuous readings of the contact forces and the location of the contact points. These parameters are presented to the user or analysed automatically and measurements are taken when the load cell signals are stable and not fluctuating continuously. In addition to that, the mode of continuous readings can be used for demonstration to a patient how objects attached to the wheelchair violate the stability of the wheelchair. A patient can see how the centre of gravity moves outside of the safe zone if heavy bags are hung to the wheelchair's back or there is excessive inclination, and that will be a demonstration to the patient of the effect caused by heavy bags or body inclining.

In some embodiments of the invention there may be the following features. There are four arrays, there are four platforms on which wheels of the vehicle are placed, and each array is associated with a respective platform to provide data for determining the load on the platform through a wheel placed on the platform and the position of the wheel on the platform; the platforms being arranged to provide leading left and leading right platforms and trailing left and trailing right platforms; and wherein the vehicle has front left and front right wheels and rear left and rear right wheels; and the method comprises a first step of positioning the front left wheel on the leading left platform, and the front right wheel on the leading right platform, whilst the rear wheels of the vehicle remain off the platforms, before the leading platforms, and reading data from the sensors; a second step of moving the wheelchair so that the front left wheel is on the trailing left platform, the front right wheel is on the trailing right platform, the rear left wheel is on the leading left platform, and the rear right wheel is on the leading right platform, and reading data from the sensors; and a third step of moving the vehicle so that rear left wheel is on the trailing left platform, the rear right wheel is on the trailing right platform, whilst the front wheels of the vehicle remain off the platforms, beyond the trailing platforms, and reading data from the sensors.

In one embodiment of such a method, the vehicle has either front or rear wheels in the form of casters which can adopt a forwards facing configuration or a rearwards facing configuration; and the first, second and third steps are carried out once with the casters in the forwards facing configuration and once with the casters in the rearwards facing configuration.

In another, simplified, embodiment the vehicle also has either front or rear wheels in the form of casters which can adopt a forwards facing configuration or a rearwards facing configuration; the first step is carried out with casters in the rearwards facing configuration; the second step is carried out with casters in the rearwards facing configuration; and the third step is carried out with the casters in the forwards facing configuration.

Preferably, in embodiments using vehicles with casters, the direction in which the vehicle is moved on to or off of the platforms determines whether the casters adopt the forwards facing configuration or the rearwards facing configuration.

In a preferred embodiment using a vehicle with casters, the vehicle is a wheelchair and the casters are the front wheels.

In preferred embodiments of the invention, the stability is assessed by determining the angle to which the vehicle can be tilted whilst the projection of the centre of gravity of the vehicle remains within the footprint of the vehicle as defined by the points of contact of the wheels of the vehicle.

Some embodiments of the invention will now be described by way of example and with reference to the accompanying drawings, in which:

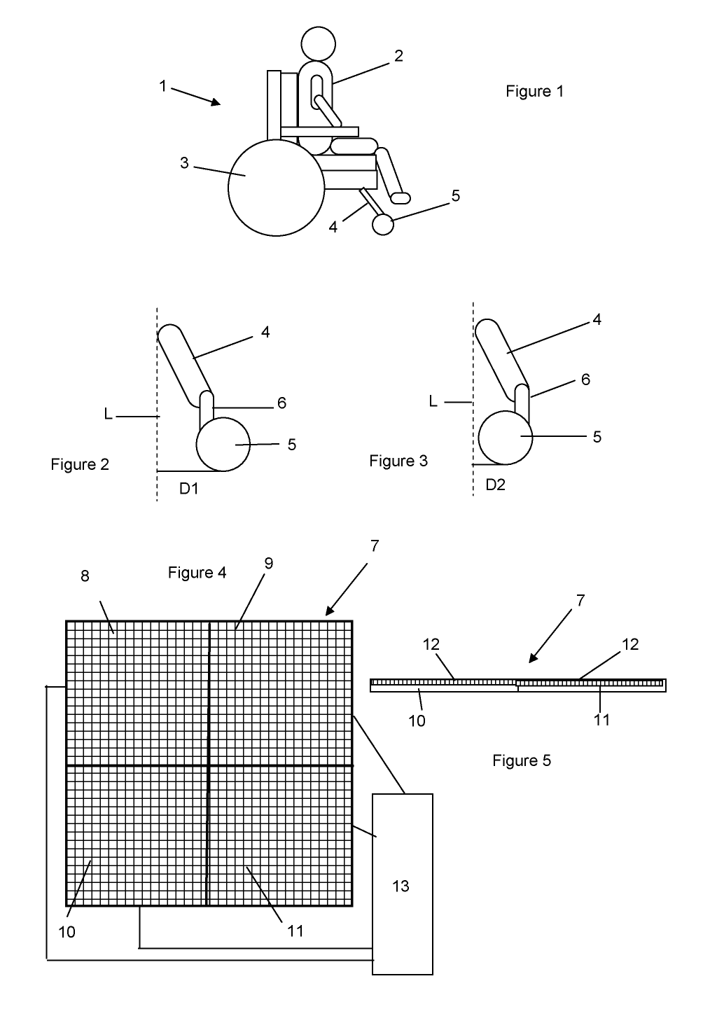

FIG. 1 is a side view of a wheelchair;

FIG. 2 is an enlarged view of a front wheel assembly of the wheelchair, in a first condition;

FIG. 3 is an enlarged view of the front wheel assembly of the wheelchair, in a second condition;

FIG. 4 is a plan view of an assessment platform;

FIG. 5 is a side view of the platform;

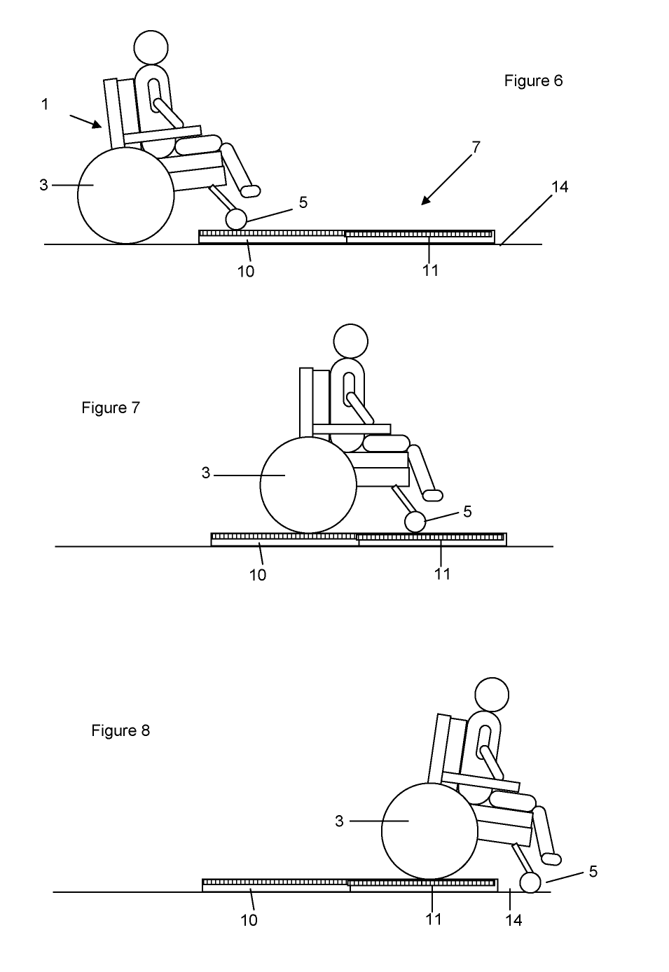

FIG. 6 is a side view of the wheelchair partly on the platform;

FIG. 7 is a side view of the wheelchair fully on the platform;

FIG. 8 is another side view of the wheelchair partly on the platform; and

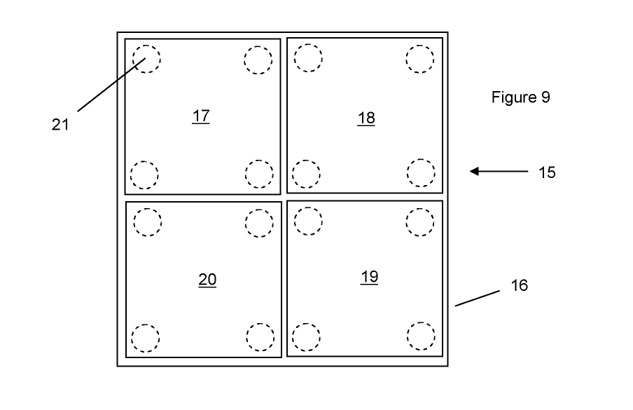

FIG. 9 is a plan view of an alternative embodiment of assessment apparatus.

As shown in FIG. 1, a wheelchair 1 has a seated occupant 2. The wheel chair has a large diameter rear wheel 3 on each side, and a front wheel assembly 4 on each side, carrying a small diameter front wheel 5. The front wheel 5 is part of a caster and as shown in FIGS. 2 and 3 is mounted by an upright pivot pin 6 so that it can swivel between the position shown FIG. 2, where there is a first distance D1 between the point of engagement of the wheel on a surface and a base line L, and the position shown FIG. 3, where there is a second distance D2 between the point of engagement of the wheel on a surface and the base line L, with D1 being greater than D2.

FIG. 4 shows an assessment platform 7, formed by four sub platforms 8, 9, 10 and 11. Each sub-platform carries an array 12 of load sensors arranged on a grid, which can detect the load applied by a wheel on the sub-platform and the position of the wheel on the sub-platform. The sensors are connected to a data processing system 13, such as a laptop computer. The platform can be folded up or stacked up with the sub-platforms one above the other,

To assess the stability of the wheelchair, it is placed on the platform using the following steps. Step 1: As indicated in FIG. 6, initially, only the front caster wheels 5 rest on two sub-platforms 8 and 10 and the rear wheels are on the ground 14. Readings of the force reactions of these front wheels are taken using the arrays of sensors. Step 2: The wheelchair is pushed forward until each wheel is on the platform, each wheel being on a separate sub-platform, as shown in FIG. 7. The front wheels 5 are oriented to the rear, as in the position shown in FIG. 3. Readings of the force reactions of all four wheels are recorded, using the arrays of sensors. Step 3: The wheelchair is pushed further until the point shown in FIG. 8, when the front wheels 5 leave the platform and rest on the ground 14. The rear wheels rest on the sub-platforms 9 and 11. The front wheels 5 are still oriented to the rear. The reaction forces of the rear wheels are measured. Step 4: The wheelchair is pushed further forward and then it is pulled back. The rear wheels rest on the sub-platforms 9 and 11 and the front wheels 5 rest on the ground 14. As a difference from the previous step, here the front wheels 5 have been caused to rotate through 180 degrees to take up the position shown in FIG. 2. The measurements of the forces on the rear wheels are taken. Step 5: The wheelchair is pulled back further until all four wheels rest on a separate sub-platform. The difference over step 2 is that the front wheels 5 have been rotated through 180 degrees. The measurements of all four force reactions are taken. Step 6: The wheelchair is pulled back further until the rear wheels 3 are on the ground and the front wheels rest on the sub-platforms 8 and 10. The difference with step 1 is that the front wheels are turned through 180 degrees. Measurements of the forces of the front wheels are taken. The wheelchair can then be removed from the platform. The data processing system calculates the various distances between the wheels, as well as measuring the loads. The readings from the sensors are taken when the wheelchair is stationary.

In the above embodiment, six steps are described. However, for calculation of all parameters it will be enough to use only steps 1, 2, and 4. The use of six steps is not always necessary. When six measurement sequences are used, some of the parameters (forces and linear measurements) are measured a few times. In this case, the calculations of the centre of gravity are based on the average values of these parameters. When six sequences are used, the measurement of the centre of gravity can be carried out most accurately. Eventual errors can be detected easily and can be minimised automatically by averaging of the results from few measurements. All measurements necessary for the calculation of the centre of gravity can be obtained by using three steps only (step 1, 2, and 4 as described above). This short procedure can be used when a quick measurement process is needed and accuracy is not essential (for example, for a quick verification about the stability of a wheelchair). When precise measurements are required, it will be preferable to use the measurement procedure based on six steps. For the calculations of the 3D position of the centre of gravity, the height of the platform is preliminarily known.

The new measurement procedure is very quick and natural. Initially, the wheelchair is pushed forward (for steps 1, 2, and 3) and then the wheelchair is pulled back (steps 4, 5, and 6).

In the above method, it is not necessary to measure manually the distances between the front and rear contact points when the castor wheels are rotated by 180 degrees. In the above method, this is calculated automatically by comparing the wheelbases in steps 2 and 4.

In the system in accordance with the invention, the end goal is the prediction of the maximal inclination angles for which the wheelchair is stable. The wheelchair will tip over if that tipping angle is exceeded. For calculation of the tipping angles, it is necessary to measure the weight that each of the wheels applies to the measurement platform. In addition, it is necessary to know the distance between the contact points of the wheels and the platform surface. The final goal is the calculation of the tipping angles from the geometry information that is used and weight measurements. In an experiment there was used a wheelchair with a dummy (100 kg) fixed in a seating posture on a wheelchair. In a first part of the experiment, the wheelchair was placed on a rigid platform and one end of this platform was raised in order to imitate an inclined road. The front wheels of the wheelchair were raised to the point when the wheelchair was about to tip over. We measured the inclination angle with a precise digital inclinometer and recorded the tipping angle. In a second part of the experiment, an embodiment of a system in accordance with the invention was used to measure the stability of the same wheelchair by following the measurement procedure described above. For that purpose, initially, the front wheels of the wheelchair were placed on the e platform while the rear wheels were on the ground. The weights caused by these front wheels were automatically recorded. Next, all four wheels of the platform were positioned over the four separate measurement plates of the system and a new set of weight measurements was taken. Third, while the wheelchair was on the plates, the front castor wheels were rotated on 180 degrees and the system recorded the weights on each plate. In addition, the wheel diameters of the wheelchair were entered to the computer system.

For calculation of the tipping angles information about the distances between the contact points of the wheels is needed but as explained previously, the system senses the position of each contact point and measures automatically the distances between the contact points. In this part of the experiment, it was found that the measurement error of the position of application of the force does not exceed 5 to 6 mm. The difference between the measured tipping angle during the first experiment and the tipping angle calculated by the new system did not exceed 0.3 angular degrees. Such a result is acceptable for clinical practice, and there may not be many people who can sense inclination difference of 0.3 to 0.5 degrees.

FIG. 9 is a diagram of apparatus in accordance with the invention used in conducting the above experiment. The apparatus 15 comprises a base 16 over which are arranged four square load platforms 17, 18, 19 and 20. Each platform is supported by four load sensors 21 positioned between the platform and the base, there being a load sensor adjacent each corner of each platform. The positions of the platforms relative to the base are fixed and known, and the four sensor outputs for each platform can be used to detect the position of a wheel on each platform, and thus the distances between the wheels can be calculated. The four sensors for each platform are used to determine the weight being transmitted through the wheel on that platform.

Some advantages of a method in accordance with the invention are that the user's experience is improved, the measurement time is shorter, and the experiences of the user and the assessor are improved. It is not necessary to measure the distances between pairs of wheels, since the distances are calculated automatically.

The invention can be expressed in a number of different ways. For example, viewed from another aspect the invention provides a method of assessing the stability of a wheeled mobility assistance vehicle, using at least one array of load sensors on which the wheels of the vehicle are placed, the sensors of the array being of sufficient resolution to sense the load imposed by an individual wheel of the vehicle and to detect the position of that individual wheel, there being data processing means which calculates the distances between the wheels of the vehicle from the positions detected by sensors, and uses those distances and the loads imposed by the wheels of the vehicle to determine the position of the centre of gravity of the vehicle. Viewed from another aspect the invention provides a method of assessing the stability of a wheeled mobility assistance vehicle, using at least one array of load sensors on which the wheels of the vehicle are placed, the sensors of the array being of sufficient resolution to sense the load imposed by an individual wheel of the vehicle and to detect the position of that individual wheel, wherein the distance between at least one pair of wheels of the vehicle is calculated from the positions detected by sensors, and that distance and the loads imposed by the wheels of the vehicle are used to determine the position of the centre of gravity of the vehicle.

1. A method of assessing the stability of a wheeled mobility assistance vehicle having a plurality of wheels, by determining the position of the centre of gravity of the vehicle, using at least one array of load sensors on which the wheels of the vehicle are placed, the sensor array providing data sufficient to permit determination of the position of a wheel, the sensors of the array supplying data to a data processing system which calculates from that data the load imposed by individual wheels of the vehicle, the positions of those individual wheels and thus distances between the wheels of the vehicle, and uses those distances and the loads imposed by the wheels of the vehicle to determine the position of the centre of gravity of the vehicle.

2. A method as claimed in claim 1, wherein there is a plurality of arrays and when data is supplied from an individual array for calculations to be made by the data processing system, no more than one wheel is associated with the individual array

3. A method as claimed in claim 2, wherein there are four arrays.

4. A method as claimed in claim 2, wherein there is a corresponding plurality of platforms on which wheels of the vehicle are placed, and each array is associated with a platform to provide data for determining both the load on the platform through a wheel placed on the platform and the position of the wheel on the platform.

5. A method as claimed in claim 4, wherein each platform is rectangular and the array of sensors associated with a platform comprises four sensors, one adjacent each corner of the platform.

6. A method as claimed in claim 4, wherein the sensor arrays and the platforms are arranged on a base and the positions of the platforms on the base are known.

7. A method as claimed in claim 1, wherein there are four arrays, there are four platforms on which wheels of the vehicle are placed, and each array is associated with a respective platform to provide data for determining the load on the platform through a wheel placed on the platform and the position of the wheel on the platform; the platforms being arranged to provide leading left and leading right platforms and trailing left and trailing right platforms; and wherein the vehicle has front left and front right wheels and rear left and rear right wheels; and the method comprises a first step of positioning the front left wheel on the leading left platform, and the front right wheel on the leading right platform, whilst the rear wheels of the vehicle remain off the platforms, before the leading platforms, and reading data from the sensors; a second step of moving the wheelchair so that the front left wheel is on the trailing left platform, the front right wheel is on the trailing right platform, the rear left wheel is on the leading left platform, and the rear right wheel is on the leading right platform, and reading data from the sensors; and a third step of moving the vehicle so that rear left wheel is on the trailing left platform, the rear right wheel is on the trailing right platform, whilst the front wheels of the vehicle remain off the platforms, beyond the trailing platforms, and reading data from the sensors.

8. A method as claimed in claim 7, wherein the vehicle has either front or rear wheels in the form of casters which can adopt a forwards facing configuration or a rearwards facing configuration; and the first, second and third steps are carried out once with the casters in the forwards facing configuration and once with the casters in the rearwards facing configuration.

9. A method as claimed in claim 7, wherein the vehicle has either front or rear wheels in the form of casters which can adopt a forwards facing configuration or a rearwards facing configuration; the first step is carried out with casters in the rearwards facing configuration; the second step is carried out with casters in the rearwards facing configuration; and the third step is carried out with the casters in the forwards facing configuration.

10. A method as claimed in claim 8, wherein the direction in which the vehicle is moved on to or off of the platforms determines whether the casters adopt the forwards facing configuration or the rearwards facing configuration.

11. A method as claimed in claim 8, wherein the vehicle is a wheelchair and the casters are the front wheels.

12. A method as claimed in claim 1, further comprising determining an angle to which the vehicle can be tilted whilst the projection of the centre of gravity of the vehicle remains within a footprint of the vehicle as defined by the points of contact of the wheels of the vehicle.
